(19) United States
(12) Patent Application Publication
(10) Pub. No.: US 2026/0050835 A1
(43) Pub. Date: Feb. 19, 2026

(54) SYSTEM AND METHOD FOR TRAINING OPEN-VOCABULARY OBJECT DETECTORS USING GENERATED REGION-TEXT PAIRS

(71) Applicant: CARNEGIE MELLON UNIVERSITY, Pittsburgh, PA (US)

(72) Inventors: Marios Savvides, Pittsburgh, PA (US); Fangyi Chen, Pittsburgh, PA (US); Han Zhang, Pittsburgh, PA (US); Zhantao Yang, Pittsburgh, PA (US)

(73) Assignee: CARNEGIE MELLON UNIVERSITY, Pittsburgh, PA (US)

(21) Appl. No.: 19/297,823

(22) Filed: Aug. 12, 2025

Related U.S. Application Data
(60) Provisional application No. 63/683,594, filed on Aug. 15, 2024.

(51) Int. Cl. G06N 20/00; G06F 40/205; G06V 10/77; G06V 20/70

(52) U.S. Cl. CPC G06N 20/00; G06F 40/205; G06V 10/7715; G06V 20/70

(57) ABSTRACT

Disclosed herein is a method of generating region-text pairs for training open-vocabulary object detection. The method innovates text-to-region and region-to-text processes, along with the introduction of a Scene-Aware Inpainting Guider and a Localization-Aware Region-Text Contrastive Loss.

### RELATED APPLICATIONS

This application claims the benefit of U.S. Provisional Patent Application No. 63/683,594, filed Aug. 15, 2024, the contents of which are incorporated herein in their entirety by reference.

### BACKGROUND OF THE INVENTION

Deep learning models trained on sufficient defined-vocabulary data are effective in solving object detection tasks, but in the open world, detecting thousands of object categories remains a challenge. While traditional object detection is limited to a fixed set of object classes for which it has been trained, open-vocabulary object detection (OVD) is expected to be able to detect objects of arbitrary novel categories that have not necessarily been seen during training. In theory, OVD models should be able to identify and localize objects from a much broader, even potentially infinite, vocabulary of object categories. However, current state-of-the-art OVD is lacking in its capabilities.

Recently, the advancements in vision-language models have improved open-vocabulary tasks through the utilization of contrastive learning across a vast scale of image-caption pairs. However, training object detectors needs region-level annotations (i.e., annotating specific objects of regions in the image). Unlike web-crawled image-caption pairs, region-level instance-text (region-text) pairs are limited and expensive to annotate.

Some recent approaches focus on acquiring region-level pseudo labels by mining structures or data augmentation from image-caption pairs. These approaches are typically designed to align image regions with textual phrases extracted from corresponding captions. This is achieved by either leveraging a pre-trained OVD model to search for the best alignment between object proposals and phrases, or through associating the image caption with the most significant object proposal. However, such web-crawled data typically lack of accurate image-caption correspondence as many captions do not directly convey the visual contents, as shown in FIG. 1A. In addition, the precision of alignment is significantly dependent on the performance of the pre-trained OVD models, resulting in a recursive dilemma: a good OVD detector is requisite for generating accurate pseudo predictions, which in turn are essential for training a good OVD detector.

### SUMMARY OF THE INVENTION

Disclosed herein are systems and methods that leverage generative models to synthesize a rich corpus of region-text pairs for training an OVD, and methods for training the OVD. Unlike OVD models whose training relies on limited detection/grounding data, generative models are typically trained on extensive datasets that have both imagery and textual modalities.

More specifically, the disclosed invention is rooted in the web-crawled image-caption pairs and operates under two paradigms: text-to-region (T2R) and region-to-text (R2T). In the text-to-region process, a diffusion model is guided to execute the inpainting, conditioned on extracted caption phrases and image-predicted proposal boxes. A key design of this process is the allocation of phrases and boxes to achieve overall layout harmony. This is facilitated by training a novel scene-aware inpainting guider (SAIG), designed to comprehensively interpret a multi-modal scene and sample flexible layouts that guide the inpainting within contextually relevant and geometrically coherent regions.

In the region-to-text process, applying a powerful captioning model on object proposals is an effective way to generate region-text pairs. The generation exhibits three novel characteristics: Firstly, rather than applying generative models on pre-existing detection datasets, the generation disclosed herein is based on image-caption pairs that are scalable and mirror the real-world distribution, aligning well with the nature of open-vocabulary setting. Secondly, the generation process is structured without knowing the novel categories in advance. Thirdly, models from two distinct domains introduce a breadth of semantic richness and knowledge, enhancing the diversity of the generated data, as shown in FIGS. 1B and 1C.

To effectively use the generated region-text pairs, contrastive learning is expended to fit detection learning scenarios by incorporating not only the generated region-text pairs but also the adjacent, less accurate regions to learn with dynamic targets and weights. This loss function, termed Localization-Aware Region-Text Contrastive Loss, can be integrated into the training pipeline of various object detectors, allowing for joint training with standard detection data.

Disclosed herein is a framework that generates open-vocabulary region-text pairs from image-caption pairs. First, the framework features a text-to-region process, which is the first attempt to synthesize region-text pairs for training OVD without prior knowledge of the novel categories, as well as a region-to-text process that populates the generation with abundant regional captions. Second, a novel scene-aware inpainting guider is used to facilitate text-to-region generation. Third, a new loss function is disclosed which enables detectors to effectively learn from generated region-text pairs.

### BRIEF DESCRIPTION OF THE DRAWINGS

By way of example, specific exemplary embodiments of the disclosed system and method will now be described, with reference to the accompanying drawings, in which:

FIG. 1A is an illustration of how image-caption pairs may lack visual-textual correlation.

FIG. 1B is an illustration of the generative process of the present invention used to introduce a breadth of visual and textual diversity.

FIG. 1C is a graph showing the average precision on OV-COCO novel classes when training with different percentages of data generated using the disclosed invention. A steep increase is demonstrated when R2T+T2R is applied, evidencing a marked improvement proportional to the volume of data utilized.

FIG. 2 is a schematic of the generation portion of the framework of the present invention in which region-text pairs are generated from image-caption pairs through T2R and R2T processes.

FIG. 3 is a schematic of the training portion of the framework of the present invention. Detectors are trained via a localization-aware region-text contrastive loss.

FIG. 4 is a schematic illustration of the scene-aware allocation for inpainting, A scene-aware Inpainting Guide is used to allocate layout with the awareness of the scene.

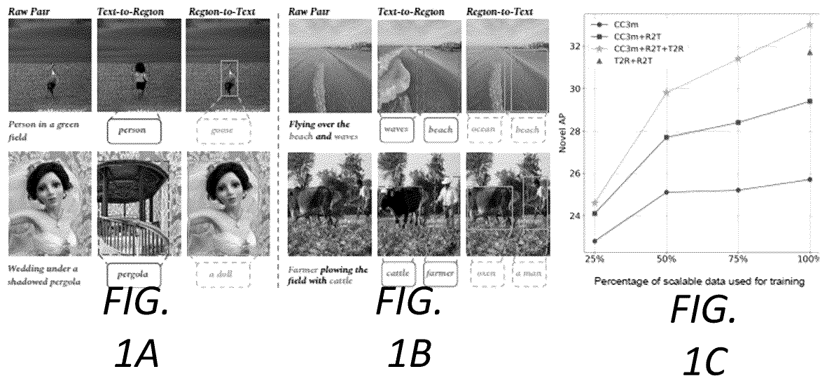

### DETAILED DESCRIPTION

Initially, an object detector is trained on a detection dataset with a predefined set of base object categories C^{base}, During this process, external image-caption pairs with an abundant list of vocabulary C^{open} are leveraged. During testing, the detector is expected to detect arbitrary novel object categories C^{novel}, where C^{base}∩C^{novel}=Ø. In a strict open-vocabulary setting, C^{novel} are only known in testing.

Given an image-caption pair, the goal of the disclosed invention is to generate a set of region-text pairs {(rⱼ, tⱼ)}_{j∈[N]′} where rⱼ denotes a region in an image bordered by a bounding box, and tⱼ denotes the text (phrase) that semantically aligns with rⱼ. Subsequently, the region-text pairs are used to train the open-vocabulary object detectors.

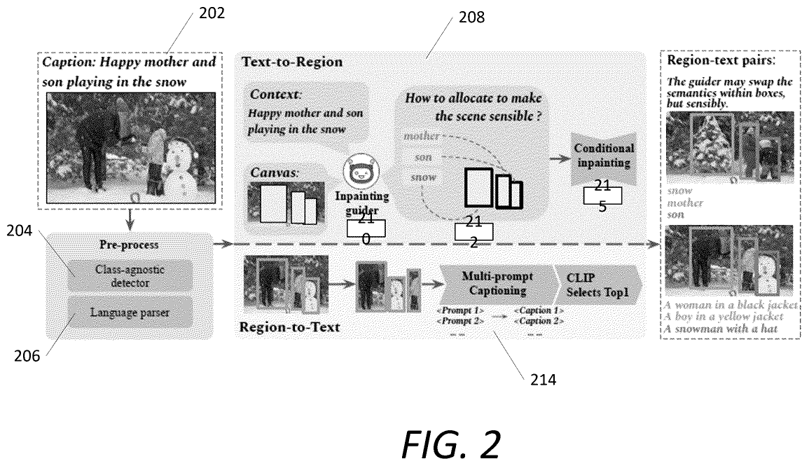

An overview of the disclosed framework is illustrated in FIG. 2. The process starts with image-caption pairs 202 with two pre-processing steps.

First, a class-agnostic detector 204 is applied to the image to produce proposal boxes. In one embodiment, regions of interest in the images are identified before applying the generation models. Specifically, an off-the-shelf class-agnostic object proposal generator (e.g., Multi-Vision Transformer) is used to predict object proposals with the text prompts “all objects” and “all entities”. Regions with a confidence score above 0.3 are kept and ensembled. To avoid repetitive region proposals, all regions are first filtered by the non-maximum suppression (NMS) process with a 0.1 IoU threshold.

Second, a large language model 206 is employed on the caption to parse the caption to identify tangible and physical phrases. In one embodiment, a large language model (e.g., Mistral and NLTK word-tree) is used to extract phrases that are suitable for inpainting from captions. Directly using a prompt like “please list tangible objects in the sentence” often produces sub-optimal results and gives incorrect phrases such as “beauty”, “university”, “sunday”, and “nightmare”. Therefore, an instruct-finetuned variant (e.g., Mistral-8x7B-Instruct-v0.2) is used, wherein several examples are prompted and Prompt+Instruct is used for in-context learning. The selected examples and prompt template are shown in the table below.

Prompt:
Export the real-world objects with a physical body in the sentence, return None if not found.
Instruct:
User: burger: pound of fries and some sauces, man talking on his smart phone on the beach in
cloudy dark weather. Assistant: burger, fries, some sauces, man, smart phone.
User: medical team working together at night, taking care of patients carefully on a hospital
ward. Assistant: mediacal team, patients.
User: night display of sculptures during olympic games. Assistant: sculptures.
User: where is the sea in space?. Assistant: None

Afterwards, a word-tree is used to filter the extracted phrases by the hierarchy with allowance and forbidden categories, summarized in the table below. If a phrase's hypernym appears or disappears in both categories, it will be dropped.

| Allowance | Forbidden |
|---|---|
| ‘physical entity’, ‘food’, ‘person’, ‘living | ‘measure’, ‘atmosphere’, ‘time’, ‘activity’, |
| thing’, ‘social group’, ‘biological group’ | ‘phenomenon’, ‘event’, ‘meeting’, |
| | ‘organization’, ‘location’, ‘land’, ‘facility’ |

### Text-to-Region

After preprocessing, the extracted phrases are input into the text-to-region portion 208 of the generation framework, where the text-to-region phase is executed by a scene-aware inpainting guider (SAIG) 210 followed by an inpainting model.

The purpose of the text-to-region (T2R) generator is to generate text associated with regions of the input image. The regions are identified by the class-agnostic detector 204 used as part of the preprocessing of the image. The text assigned to each region is extracted from a caption generated by language parser 206. A trained scene-guider (SAIG 210) is used that reads as input the region-masked image as well as the caption and then decides which text to associate with which identified region at 212. Subsequently, image inpainting 215 is used to complete the generation. As can be seen from the example in FIG. 2, three regions have been identified and have been associated with the captions “snow”, “mother” and “son”.

In one embodiment, SAIG 210 is constructed with 32 layers of multi-head self-attention. In one embodiment, CLIP-Vit-L/14 is used as a feature extractor. The box encoder contains three fully-connected layers with SiLU activation function in between. The cross-entropy loss is applied for training. AdamW with learning rate=1e-4 is chosen as the optimizer. The guider is trained with 8xA100 GPUs for 12 epochs until it converges.

Image-caption pairs ensure the generation inherits visual and semantic richness. Although generating images from texts with the controllability of layout has been widely researched in recent years, the generation of image regions from image-caption pairs remains underexplored.

Inpainting Image-Caption Pairs. An image inpainting module directly gives region-text alignment while preserving a substantial proportion of the original image, thus transferring the realism and diversity of the images to the generated output, particularly in the context regions, which is critical within the setting of open-vocabulary detection. Considering an image I, a phrase t, and a specified proposal box b. An inpainting model, denoted as [symbol] , can replace the original visual content inside b (region r) with a newly generated region \hat{r}, where:

$$\hat{r} = {𝒢}_{I} ( I , ( b , t ) ) \qquad ( 1 )$$

where \hat{r} is aligned with t semantically, while the rest of the image I\r remains unchanged.

When inpainting an image-caption pair, N proposal boxes [symbol] ={b₁, b₂, . . . , b_{N}} are acquired from the image and M extracted phrases [symbol] ={t₁, t₂, . . . , t_{M}} from the caption by the pre-processing. Here, a preliminary step is to allocate proposal boxes and phrases to get a harmonious layout. Several characteristics of this task are recognized: (1) There exists t that is not related to any region in the image, and vice versa. (2) A box b could be of any shape and located in any context, yet in natural images, regions with a semantic meaning may follow certain geometric distributions.

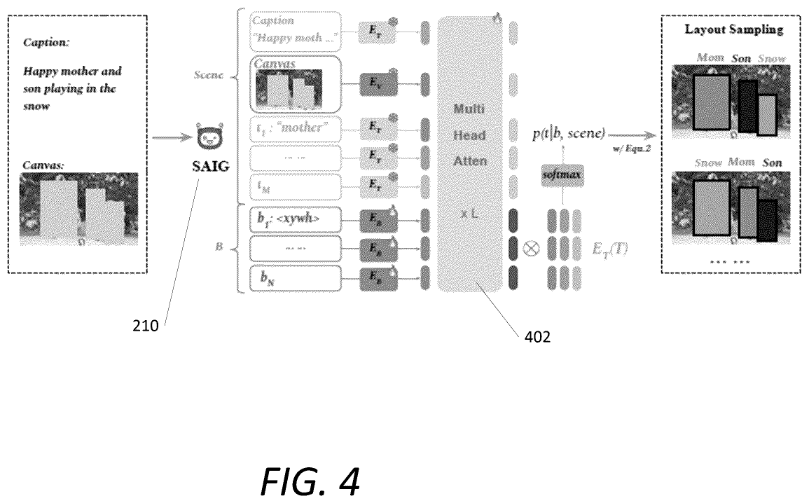

With these considerations, a novel approach to scene-aware allocation for inpainting that can sample a harmonious layout by allocating the [symbol] and [symbol] , based on its understanding of the scene is disclosed. As an example, shown in FIG. 4, the core challenge is to understand “Happy mother and son playing in the snow” and allocate the phrases “mother”, “son”, and “snow” to the proper boxes. It is worth noting that, for obtaining region-text pairs, it's unnecessary to inpaint a region with a phrase that replicates its original visual content (e.g., by grounding). Instead, the preferred design is that the inpainting process will flexibly conform to a distribution that is contingent on the scene's context and is consistent with what is typically observed in the real world.

Scene-Aware Inpainting Guider (SAIG). The probability of allocating a pair (b_{N}, t_{M}) as a joint probability p_{NM}=P(b_{N}, t_{M}| scene) is modelled, which is decomposed equally as:

$$P ( {b}_{N} , {t}_{M} \vert scene ) = P ( {t}_{M} \vert {b}_{N} , scene ) \times P ( {b}_{N} \vert scene ) \qquad ( 2 )$$

In Eq. (2), P(t_{M}|b_{N}, scene) represents the probability of phrase t_{M} to be picked for inpainting within b_{N}, while P(b_{N}|scene) represents the existence of b_{N} in the scene. P(t_{M}|b_{N}, scene) is parameterized by a multi-modal multi-layer bidirectional transformer encoder 402, illustrated in FIG. 4. Both visual and textual modalities are engaged from the image-caption pair. For the visual modality, the image is obscured within the specified proposal boxes and employs the remaining background as a canvas. This canvas prevents the model from gaining knowledge of the original content within the proposal boxes, encouraging it to focus on flexible layout generation. The caption and canvas are encoded, in one embodiment, by a contrastive language-image pre-training (CLIP) textual encoder (E_{T}) and visual encoder (E_{V}), respectively, and projected onto the same visual-semantic space. To facilitate scene understanding, some caption phrases that have been extracted in preprocessing are emphasized by individually encoding them through E_{T}. The scene is thereby a set of tokens:

$$scene = \{ {E}_{T} ( caption ) , {E}_{V} ( canvas ) , {E}_{T} ( {t}_{1} ) , {E}_{T} ( {t}_{2} ) , … {E}_{T} ( {t}_{M} ) \} \qquad ( 3 )$$

The b_{N} has a form of [symbol] x, y, w, h [symbol] . It is first encoded through Fourier embedding (FE) and then project it to the same dimension as the other tokens by a trainable multi-layer perceptron (MLP), formally, E_{B}(b_{N})=MLP(FE(b_{N})). All encoded modalities are incorporated into the transformer layers with each consisting, in one embodiment, of a multi-head self-attention block (MHA), an MLP layer, and LayerNorm. The output token of the by embedding is utilized to conduct dot product with encoded texts, followed by softmax function to calculate the probability that text t_{M} should be inpainted in by:

$$P ( {t}_{M} \vert {b}_{N} , scene ) = \frac{exp ( MHA ( {E}_{B} ( {b}_{N} ) , scene ) \cdot {E}_{T} ( {t}_{M} ) )}{{\sum }_{j = 1}^{M} exp ( MHA ( {E}_{B} ( {b}_{N} ) , scene ) \cdot {E}_{T} ( {t}_{j} ) )} \qquad ( 4 )$$

Furthermore, to get P(b_{N}|scene) the confident score from the class-agnostic detector is used in pre-processing to reflect the probability of the existence of b_{N} in the scene. As such Eq. (2) could finally be used to calculate P(t_{M}, b_{N}|scene), which is used to sample diverse and flexible layouts, based on nucleus sampling.

Filtering—The SAIG provides allocated layouts that guide image inpainting model to generate region-text pairs. The generated images may contain low-quality regions and thus, it is important to have quality control. Two levels of filtering are applied: image level filtering and region level filtering. An image aesthetic model is run on the generated data. Low-scored data is usually low-quality, while very high-scored data is mostly landscape painting and natural scenery, and neither are ideal for instance-learning. Additionally, CLIP is applied as a region-level filter on each region-text pair.

As explained, the generated images may contain low-quality regions, which need to be filtered before the training of the detectors. As mentioned, both image-level filtering and region-level filtering are applied. An aesthetic filter is applied and the 95^{th} percentile interval threshold t₁ and t₂ is selected for all images. The images with aesthetic scores outside of the range (t₁, t₂) are filtered out. In one embodiment t₁=3.0 and t₂=6.0 are selected. Note that images with high aesthetic scores are also removed because most of them contain natural scenery, which is not ideal for region-text alignment learning. Subsequently, an adaptive region-level filter is applied to remove inpainted regions with poor quality and, in one embodiment, a pretrained CLIP model is used as a filter. For a generated region-text pair, the cosine similarity scores are calculated between the region and all the text phrases. A region annotation will be filtered out if the similarity score between the region and the correspondent text phrases is less than the top 5% of all the text phrases. A dynamic threshold works better than a fixed threshold as it preserves text phrases that might have multiple synonyms.

### Region-to-Text

The region-to-text generation 214 portion of the framework is conducted by a captioning model and a subsequent selection step and augments the textual richness of the region proposals.

The image-caption pairs that are utilized are mostly sourced from the web, which often results in captions that are erroneous, incomplete, or only partially related to the image subjects. As such, a large portion of the original captions only capture one or two salient entities instead of mentioning all the semantic details, while some of the captions are simply not directly related to the subject of the image. The potential of these image-caption pair data is leveraged by generating region-level descriptions via an image captioning model trained in a distinct domain, thus enriching the overall system with semantic details at a granular level. The resulting generated data is both format-compliant and complementary to the text-to-region 208 counterpart.

Given an image I, regions {r₁, r₂, . . . , r_{N}} are obtained by cropping the image with enlarged proposal boxes [symbol] which include context for enriched background information. To prevent semantic overlaps and duplicated annotations, all proposal boxes are initially processed by Non-Maximum Suppression. In one embodiment, a pre-trained image captioning model [symbol] is applied to generate a set of region-level descriptions T={t₁, t₂, . . . , t_{N}}, where a prompt is used to guide the model to interpret the image:

$$= select ( {𝒢}_{𝒯} ( {r}_{i} , {prompt}_{1} ) , {𝒢}_{𝒯} ( {r}_{i} , {prompt}_{2} ) , {𝒢}_{𝒥} ( {r}_{i} , {prompt}_{3} ) ) \qquad ( 5 )$$

In detail, [symbol] , are generated by a selecting operation across an ensemble of three text prompt prefixes, for example, “The image shows < >”. As a result, the best matching caption for each region proposal is selected according to the highest-ranking CLIP similarity score between the region crops and their generated captions. It is predictable that the more prompts selected from, the higher the score, but in practice, three is a good balance between efficiency and effectiveness.

### Training the OVD

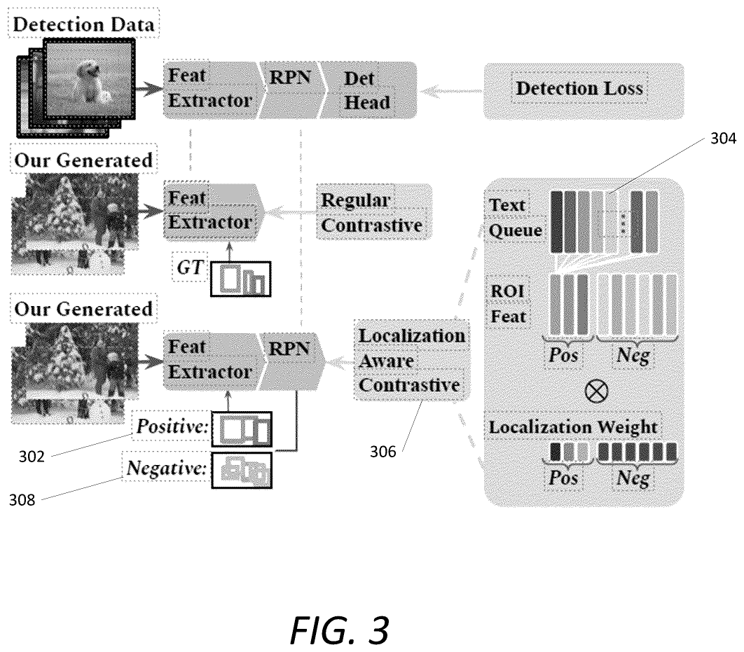

The training portion of the framework, in which the OVD is trained with the generated region-text pairs, is schematically shown in FIG. 3. The generated region-text pairs incorporate contrastive learning and the novel localization-aware region-text contrastive loss, jointly training with detectors.

Contrastive learning can be used in OVD to force visual features to be similar to their textual features. Here, region-text contrastive learning is expanded to learn additional object proposals tailored with different localization qualities.

Region-Text Contrastive Loss. Given an image-caption pair, for i^{th} region rᵢ ROIAlign is used on the detector's feature pyramid to extract visual embedding E_{R}(rᵢ), and a CLIP pre-trained language model is used as the text encoder to get the corresponding text embedding E_{R}(tᵢ). The pair (rᵢ, tᵢ) is recognized as a positive pair 302. During training, a text queue

$$T *= {\{ {t}_{l}^{*} \}}_{l ∈ [ L ]}$$

304 is also maintained with a queue length L, collected across previous batches. Texts in the queue are assumed dissimilar to tᵢ, and they make the negative pairs with

$${r}_{i} ( i . e . , \{ ( {r}_{i} , {t}_{1}^{*} ) , ( {r}_{i} , {t}_{2}^{*} ) , … , ( {r}_{i} , {t}_{l}^{*} ) \} ) .$$

A binary cross-entropy loss is applied:

$${ℒ}_{region - text} = \text{} - log σ [ τ \cdot cos ( {E}_{R} ( {r}_{i} ) , {E}_{T} ( {t}_{i} ) ) ] - {\sum }_{{t}_{j} ∈ {T}^{*}} log [ 1 - σ ( τ \cdot cos ( {E}_{R} ( {r}_{i} ) , {E}_{T} ( {t}_{l}^{*} ) ) ) ] \qquad ( 6 )$$

where “cos” is the cosine similarity, t denotes a temperature parameter, and o is a sigmoid function.

Localization-Aware Region-Text Contrastive Loss (LART). Eq. (6) aligns rᵢ and tᵢ, but neglects the importance of precisely localized alignment. As a detector may densely predict many proposals to one single object, it is critical to make the model give the highest confidence rank to the most accurately localized prediction. To involve the awareness of localization quality in contrastive learning, LART 306 is disclosed. Starting with (rᵢ, tᵢ), K adjacent regions, that overlap with rᵢ are first obtained. These adjacent regions can be acquired from the region proposal networks or dense predictions. Their visual embedding

$$\{ {E}_{R} ( {r}_{1}^{*} ) , … , {E}_{R} ( {r}_{K}^{*} ) \}$$

is extracted and their intersection-over-union (IOU) scores {s₁, . . . , s_{K}} are computed with rᵢ as localization quality.

If a sₖ is higher than a predefined threshold α, the corresponding

$${r}_{k}^{*}$$

contains similar information as rᵢ, and a positive pair

$$( {r}_{k}^{*} , {t}_{i} )$$

302 is formed. They are trained akin to that of (rᵢ, tᵢ), but their learning loss is down-weighted by sₖ. This benefits from two perspectives: on one hand, additional positive pairs effectively enlarge the batch size and bring additional supervision; on the other hand, the rescaled loss guarantees the strongest supervision is applied to the origin pair, thus helping the detector confidently predict the optimal localization. If sₖ<α, the

$${r}_{k}^{*}$$

contains a relatively small proportion of the information from tᵢ, such that

$${r}_{k}^{*}$$

is negative to both tᵢ and T*. Especially, the negative pair

$$( {r}_{k}^{*} , {t}_{i} )$$

308 distinguishes itself as the

$${r}_{k}^{*}$$

is derived from rᵢ rather than from disparate regions, thereby yielding hard-negative examples for more fine-grained learning. Similarly:

$${ℒ}_{adjacent} = - {\sum }_{\begin{matrix}k ∈ [ K ] , \\ {s}_{k} > α\end{matrix}} {s}_{k} log σ [ τ cos ( {E}_{R} ( {r}_{k}^{*} ) , {E}_{T} ( {t}_{i} ) ) ] - {\sum }_{\begin{matrix}k ∈ [ K ] , \\ {s}_{k} > α\end{matrix}} {\sum }_{{t}_{j} ∈ \{ {t}_{i} , {T}^{*} \}} log [ 1 - σ ( τ cos ( {E}_{R} ( {r}_{k}^{*} ) , {E}_{T} ( {t}_{j} ) ) ) ] \qquad ( 7 )$$

The overall objective for LART is thus [symbol] _{LART}= [symbol] _{adjacent}+ [symbol] _{region-text}.

Overall Training Objective. With Faster-RCNN and CenterNet2, in one embodiment, the detectors can be trained parallelly on the detection data D^{det} and generated data D^{T2R}, D^{R2T}. Particularly, the image-caption pairs D^{cap} are treated as a special region-text pair and are added into training. The overall training objective for the detectors is thus:

$${ℒ}_{overall} = \{ \begin{matrix}{ℒ}_{rpm} + {ℒ}_{reg} + {ℒ}_{cls} & if I ∈ {D}^{det} \\ {ℒ}_{LART} & if I ∈ \{ {D}^{cap} , {D}^{T 2 R} , {D}^{R 2 T} \}\end{matrix}$$

Disclosed herein is the generation of region-text pairs for training open-vocabulary object detection. This invention innovates text-to-region and region-to-text processes, along with the introduction of the Scene-Aware Inpainting Guider and the Localization-Aware Region-Text Contrastive Loss for training.

As can be seen in FIG. 3, multiple methods of training can be used together. Prior art detection data and regular contrastive loss methods have been adapted to work with the identified regions of the image.

As would be realized by one of skill in the art, the disclosed systems and methods described herein can be implemented by a system comprising a processor and memory, storing software that, when executed by the processor, performs the functions comprising the method.

As would further be realized by one of skill in the art, many variations on implementations discussed herein which fall within the scope of the invention are possible. Specifically, many variations of the architecture of the model could be used to obtain similar results. The invention is not meant to be limited to the particular exemplary model disclosed herein. Moreover, it is to be understood that the features of the various embodiments described herein were not mutually exclusive and can exist in various combinations and permutations, even if such combinations or permutations were not made express herein, without departing from the spirit and scope of the invention. Accordingly, the method and apparatus disclosed herein are not to be taken as limitations on the invention but as an illustration thereof. The scope of the invention is defined by the claims which follow.

1. A method of training an open-vocabulary object detector comprising:
obtaining a plurality of image-text pairs, each image-text pair comprising an image and a text description of the image;
for each image-text pair:
applying a class-agnostic detector to isolate regions of the image containing objects and to produce a region-masked image;
applying a language parser to extract one or more captions from the text description;
applying a text-to-region generator to generate region-text pairs by assigning the one or more captions to the regions;
using the region-text pairs to train the open-vocabulary object detector.

2. The method of claim 1 further comprising:
applying a region-to-text generator to generate region-text pairs by assigning regions to phrases generated from the one or more captions.

3. The method of claim 1 wherein the text-to-region generator comprises:
a scene-aware inpainting guider that takes as input the region-masked image and the caption and determines text extracted from the caption to be associate with each region identified in the region-masked image; and
an inpainting module to generate a new image by replacing original content inside each identified region with an inpainted region aligned semantically with the associated text.

4. The method of claim 1 wherein the language parser is an instruct-finetuned large language model.

5. The method of claim 1 further comprising:
filtering the one or more extracted captions to eliminate forbidden categories.

6. The method of claim 3 wherein the scene-aware inpainting guider encodes both the image and the associated text and projects the encodings into the same visual-semantic space to determine a probability that a given caption associates with a given region.

7. The method of claim 6 wherein the visual encoding operates on the image with the content of the identified regions obscured to avoid knowledge of the original content within the identified regions becoming part of the encoding.

8. The method of claim 1 wherein the text-to-region generator further comprises:
a filter to exclude low-quality regions from the training dataset.

9. The method of claim 2 wherein the region-to-text generator:
applies an image captioning model to generate region-level descriptions.

10. The method of claim 9 wherein the image captioning model is trained in a specific domain.

11. The method of claim 9 wherein the description to which a region is assigned is the description having a highest-ranking similarity score between the description and the region.

12. The method of claim 3 wherein using the region-text pairs to train the open-vocabulary object detector comprises using region-text pairs generated by both the text-to-region generator and the region-to-text generator.

13. The method of claim 3 wherein the generated images and associated region-text pairs generated by both the text-to-region generator and the region-to-text generator are used to train the open-vocabulary object detector.

14. The method of claim 13 wherein the generated images and associated region-text pairs are used in a contrastive learning mode.

15. The method of claim 13 the contrastive learning mode uses a region-text contrastive loss.

16. The method of claim 13 the contrastive learning mode uses a localization-aware region-text contrastive loss.

17. The method of claim 16 wherein an intersection-over-union score between each region and a plurality of adjacent, overlapping regions is used to determine an overall loss.

18. The method of claim 13 wherein a detection data method, a region-text contrastive loss method using the generated images and associated region-text pairs and a localization-aware region-text contrastive loss method using the generated images and associated region-text pairs are used together to train the open-vocabulary object detector.

19. The method of claim 13 wherein any combination of a detection data method, a region-text contrastive loss method using the generated images and associated region-text pairs and a localization-aware region-text contrastive loss method using the generated images and associated region-text pairs are used to train the open-vocabulary object detector.

20. A system comprising:
a processor; and
memory, storing software that, when executed by the processor, causes the system to perform the method of claim 18.
